(19) United States
(12) Patent Application Publication
(10) Pub. No.: US 2026/0364609 A1
(43) Pub. Date: Nov. 19, 2026

(54) MODULAR ELECTROSTATIC FILM SYSTEM FOR REMOVING DUST PARTICLES AND METHOD THEREOF

(71) Applicant: SAUDI ARABIAN OIL COMPANY, Dhahran (SA)

(72) Inventors: Abdullah Faisal Arab, Dammam (SA); Mohammed Fahad Alsuwayegh, Dhahran (SA)

(73) Assignee: SAUDI ARABIAN OIL COMPANY, Dhahran (SA)

(21) Appl. No.: 19/212,062

(22) Filed: May 19, 2025

(51) Int. Cl. B03C 3/68; B03C 3/47; B03C 3/60

(52) U.S. Cl. CPC B03C 3/68; B03C 3/47; B03C 3/60

(57) ABSTRACT

A modular electrostatic film (MEF) system and method for removing dust particles. The MEF system is designed for non-contact dust removal from surfaces such as windows and building glass panels, camera lenses and optical instruments, car bodies and mirrors, and outdoor electronic screens and touch displays. The MEF includes configurable electrodes lines powered to generate an electric field that repels dust particles through electrostatic repulsion. The MEF can be cut, tiled, or layered, while maintaining electrical continuity and scalability. A hydrophobic coating layer is applied to the outer surface of the film. The hydrophobic coating layer is configured to prevent the dust particles from cementing. The system includes the MEF embedded with an array of electrode lines, a voltage source electrically connected to the array, a voltage amplifier electrically connected to the array and the voltage source, and a microcontroller electrically connected to the voltage source.

### BACKGROUND

Dust accumulation on optical and energy-harvesting surfaces, such as solar panels, glass windows, mirrors, and camera lenses, significantly reduces their performance and clarity. Conventional cleaning methods involve manual or dry scrubbing, water-based cleaning, mechanical wipers, or electrodynamic screens. These conventional methods may be labor-intensive, inefficient, expensive, or damaging to sensitive surfaces by introducing irreversible scratching. A need exists for a modular, economical, low-power, and scalable system capable of removing dust without mechanical or chemical contact.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method for removing dust particles on a modular electrostatic film (MEF) configured to be applied on an apparatus. The method may include arranging an array of electrode lines, embedding the array into the MEF, supplying a voltage to the array to create a differential electric potential between adjacent electrode lines, amplifying the voltage to a threshold electric potential, generating a non-uniform electric field between the adjacent electrode lines, manipulating the non-uniform electric field, applying a hydrophobic coating layer to an outer surface of the MEF, and repelling the dust particles from the film once the amplified voltage reaches the threshold electric potential. The MEF is configured to be applied on an apparatus, cut, and tiled along predefined modular boundaries while maintaining electrical continuity of the array. The array includes main electrode lines and branch electrode lines connected in a repeatable modular pattern. The branch electrode lines are electrically connected to the main electrode lines. Adjacent main electrode lines have differential electrical potential. The main electrode lines with same electric potential are connected by conductive material while custom cutting the film. The main electrode lines are connected by conductive material while tiling the film. The main electrode lines and the branch electrode lines have widths less than 100 microns. The spacing between adjacent electrode lines is less or equal to 1 mm. The threshold electric potential is greater or equal to 500 volts. The repeatable modular pattern includes straight lines, sine waves, pyramids, and zig zags. Supplying the voltage to the array includes charging the dust particles by electrostatic induction. Charging the dust particles includes generating electrostatic forces acting on the dust particles. Repelling the dust particles from the film includes overcoming, by electrostatic forces acting on the dust particles, gravitational forces and forces of adhesion acting on the dust particles. The voltage is supplied by a voltage source electrically connected to the array. The voltage is amplified by a voltage amplifier electrically connected to the array and the voltage source. The non-uniform electric field is manipulated by a microcontroller electrically connected to the voltage source, by varying the frequency, the shape, and the phase of the voltage. The dust particles are repelled from the film by the manipulated non-uniform electric field.

In general, in one aspect, embodiments disclosed herein relate to system for removing dust particles on a modular electrostatic film (MEF) configured to be applied on an apparatus. The system includes the MEF embedded with an array of electrode lines, a voltage source electrically connected to the array, a voltage amplifier electrically connected to the array and the voltage source, and a microcontroller electrically connected to the voltage source. The MEF is configured to be applied on an apparatus, cut, and tiled along predefined modular boundaries while maintaining electrical continuity of the array. The array includes main electrode lines and branch electrode lines connected in a repeatable modular pattern. The branch electrode lines are electrically connected to the main electrode lines. The voltage source is configured to supply a voltage to the array, charge the dust particles by electrostatic induction, create a differential electric potential between adjacent electrode lines, generate a non-uniform electric field between the adjacent electrode lines, generate electrostatic forces acting on the dust particles, and repel the dust particles from the film by overcoming, using the electrostatic forces acting on the dust particles, gravitational forces and forces of adhesion acting on the dust particles. The voltage amplifier is configured to amplify the voltage to a threshold electric potential. The microcontroller is configured to manipulate the non-uniform electric field by varying the frequency, the shape, and the phase of the voltage. The dust particles are repelled from the film, by the manipulated non-uniform electric field, once the amplified voltage reaches the threshold electric potential.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The size and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 illustrates an overview of the modular electrostatic film (MEF) system for removing dust particles in accordance with one or more embodiments of the disclosure.

FIG. 2 describes a flowchart of the modular electrostatic film (MEF) method for removing dust particles in accordance with one or more embodiments of the disclosure.

FIG. 3 illustrates various electrode patterns and corresponding electric field intensity distributions in accordance with one or more embodiments of the disclosure.

FIG. 4 illustrates a corner cut of a two-phase MEF showing possible cut lines and conductive connections in accordance with one or more embodiments of the disclosure.

FIG. 5 demonstrates a corner cut of three-phase MEF in accordance with one or more embodiments of the disclosure.

FIG. 6A, FIG. 6B, FIG. 6C, and FIG. 6D illustrate various branch electrode lines patterns in accordance with one or more embodiments of the disclosure.

FIG. 7 illustrates an example of two-phase MEF in accordance with one or more embodiments of the disclosure.

FIG. 8 illustrates an example of a three-phase MEF in accordance with one or more embodiments of the disclosure.

### DETAILED DESCRIPTION

In the following detailed description of embodiments of the disclosure, numerous specific details are set forth to provide a more thorough understanding of the invention. However, it will be apparent to a person having ordinary skill in the art that the invention may be practiced without these specific details. In other instances, well-known features have not been described in detail to avoid unnecessarily complicating the description.

Throughout the application, ordinal numbers (e.g., first, second, third) may be used as an adjective for an element (e.g., any noun in the application). The use of ordinal numbers is not intended to imply or create a particular ordering of the elements nor to limit any element to being only a single element unless expressly disclosed, such as using the terms “before,” “after,” “single,” and other such terminology. Rather the use of ordinal numbers is to distinguish between the elements. By way of an example, a first element is distinct from a second element, and the first element may encompass more than one element and may succeed (or precede) the second element in an ordering of elements.

It is to be understood that the singular forms “a,” “an,” and “the” include plural referents unless the context clearly dictates otherwise. Thus, for example, reference to “choke valve” includes reference to one or more of such choke valves.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

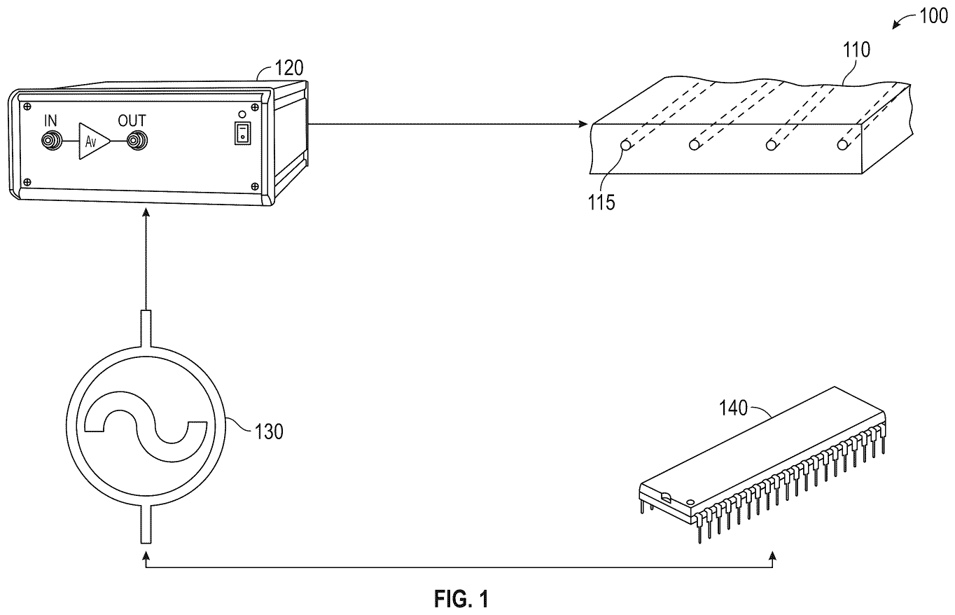

In the following description of FIGS. 1-8, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In general, embodiments of the disclosure provide a modular electrostatic film (MEF) system and method for removing dust particles. A MEF is applied to a variety of surfaces, of apparatus, that require regular cleaning. Upon supplying of a voltage from an external voltage source, the voltage is amplified by a voltage amplifier to a threshold electric potential (typically ≥500 volts), a differential electric potential is created between adjacent electrode lines. The differential electric potential between adjacent electrode lines generates a non-uniform electric field configured to exert repulsive electrostatic forces on the dust particles. As the dust particles acquire an induced charge, they are repelled from the surface in response to the non-uniform electric field. The electrode lines are configured in a customizable, repeatable pattern that can be cut, tiled, or stacked to fit different surface geometries and applications. The MEF system operates using a low-current, high voltage power source, capable of providing the necessary electric potential difference to generate an effective non-uniform electrostatic field. A detailed description is subsequently provided in reference to the figures.

The term “modular electrostatic film” refers to a film or sheet composed of one or more discrete units or modules, each capable of independent function or application. The modular configuration facilitates selective placement, removal, replacement of individual film modules, enabling customizable coverage or functionality. The film adheres to a surface through various methods depending on the surface and application type. For example, these various methods include electrostatic adhesion, chemical bonding, vacuum adhesion, mechanical fastening, and combination thereof. This flexibility of adhesion allows the film to be applied securely across diverse material surfaces such as glass, metal, or composite substrates.

The term “repeatable modular pattern” refers to a geometric or structural arrangement comprising discrete units or modules that are designed to be replicated and joined in a uniform or consistent manner across a surface or volume. Each module within the pattern maintains a consistent form factor or functional characteristic, enabling seamless repetition without disrupting the intended structural, aesthetic, or functional continuity. The pattern may be applied in two-dimensional or three-dimensional configurations and may facilitate scalable design, efficient manufacturing, ease of assembly, or customizable system architecture.

The term “differential electric potential” refers to the measurable voltage difference established between two electrode lines of the array of electrode lines embedded into the MEF. The differential electric potential is generated by the external power source.

FIG. 1 illustrates an overview of the modular electrostatic film (MEF) system for removing dust particles in accordance with one or more embodiments of the disclosure. The MEF system 100, in one or more embodiments, operates intermittently or on a pulse basis. The MEF system 100 may include optical dust sensors (not shown) or timers (not shown) to activate or pulse the MEF system 100, thereby improving energy efficiency. Despite operating at high voltage, the MEF system 100 consumes minimal power due to low current requirements and pulsed-based electric field activation. The MEF system 100 is suitable for off-grid or energy-sensitive environments. A control loop may be implemented to reduce duty cycle based on ambient dust sensors or time-of-day operation.

The MEF system 100, in one or more embodiments, includes a MEF 110 embedded with an array of electrodes 115, a voltage source 130 electrically connected to the array of electrodes 115, a voltage amplifier 120 electrically connected to the array of electrodes 115 and the voltage source 130, and a microcontroller 140 electrically connected to the voltage source 130. Each of these components is subsequently described.

The MEF 110 comprises a flexible, adhesive substrate configured to allow the MEF 110 to be applied to the apparatus that require regular cleaning. For Example, the substrate may consist of polyethylene terephthalate (PET), polyimide, or other flexible dielectric materials. The MEF 110 may be applied to a surface of various apparatuses through various methods depending on the surface and application type. For example, these various methods include, but are not limited to, electrostatic adhesion, chemical bonding, vacuum adhesion, mechanical fastening, and combination thereof. This flexibility of adhesion allows the film to be applied securely across diverse material surfaces such as glass, metal, or composite substrates. Top coatings of the MEF 110 may include hydrophobic or anti-reflective layers to enhance performance in harsh environments. For example, the MEF 110 may be applied to solar panels (e.g., transparent version using indium tin oxide or clear conductive polymers), windows and building glass panels, camera lenses and optical instruments, car bodies and mirrors (custom-colored or metallic variants), and outdoor electronic screens and touch displays. The array of electrode lines 115 include main electrode lines and branch electrode lines connected in a repeatable modular pattern. Adjacent main electrode lines have differential electric potential. The electrode lines are composed of conductive materials such as silver, copper, or graphene-based links. The array of electrode lines 115 is embedded into the MEF 110, forming a network that spans the entire surface of the MEF 110 to ensure uniform coverage and electric field generation.

The MEF 110 is configured to be cut and tiled along designated lines (predefined modular boundaries) without disrupting electrical continuity, due to consistent phase assignment and conductive connectors (e.g., conductive material such as conductive tape or adhesive). For example, the MEF 110 may use edge connectors, conductive tapes, or embedded contact pads as connection interfaces. The modular design allows for tilling the MEF 110 vertically or horizontally. The MEF 110 may support modular plug-and-play expandability. The Multiple MEF 110 may be layered to support two-phase or three-phase designs for increased efficiency. Edge markings and fiducial alignment features enable seamless integration across adjacent tiles.

In one or more embodiments, a hydrophobic coating layer (not shown) is applied to an outer surface of the MEF 110. The hydrophobic coating layer is configured to enhance environmental resilience, which further prevents the dust particles from cementing or adhering strongly due to moisture exposure or environmental contaminants. The hydrophobic coating layer is configured to reduce the adhesion of water droplets, prevent the accumulation of adsorbed-moisture particles, and complement the electrostatic cleaning effect by repelling contaminants such as rain, mud splashes, and oily residue. For example, the hydrophobic coating layer may be composed of fluoropolymer-based coatings, silane derivatives, or nano-textured superhydrophobic films applied via spray, roll-on, or chemical vapor deposition (CVD).

Large-scale deployments of the MEF 110 on solar panels may be used in arid environments to reduce efficiency loss from dust accumulation without using water. The MEF 110 (e.g., transparent version using indium tin oxide or clear conductive polymers) may be integrated into automotive windshields (e.g., electric and autonomous vehicles) for passive dust removal. The MEF 110 may be applied to inaccessible high-rise windows to minimize reliance on external cleaners. Small-format of the MEF 110 may be installed on outdoor-facing consumer electronics (e.g., smart home displays and security cameras lenses). The MEF 110 may be used in military and aerospace applications (e.g., remote sensors and optical units) where manual cleaning is not feasible.

The array of electrode lines 115 is configured with a pitch (separation between adjacent electrode lines) is less or equal to 1 mm. For example, a pitch ranging from 0.2 mm to 1.0 mm depending on application requirements. The electrode lines have widths less than 100 microns. The array of electrode lines 115 may be encapsuled between insulating polymer layers to ensure durability, moisture resistance, and user safety. For example, the encapsulating material may be PET, polyethylene naphthalate (PEN), and other comparable polymer substrates known for their electrical insulation, mechanical durability, and optical clarity.

The branch electrode lines are arranged in various geometric patterns including straight lines, sine waves, pyramids, zig zags, stairs, and other designs. These patterns influence the distribution and strength of the electric field generated. Bends in the pattern increase the intensity of the electric field locally, aiding in repelling the dust particles that are more strongly adhered. The symmetry and spacing of the pattern may be adjusted to optimize electric field gradients and target specific dust particle sizes.

A three-phase electrode lines configuration is achievable by staking multiple MEF 110 with alternating phase connections. This configuration enhances dust repulsion by generating a more complex electric field distribution. An isolation layer is maintained via dielectric interlayers. Cross-phase designs allow for adjustable pitch and targeted coverage for curved surfaces.

The voltage amplifier 120 is configured to convert low-voltage (DC or AC) input, from the power source 130, to a high-voltage output. The voltage gain Av is the ratio of the of the high-voltage output divided-by the low-voltage input. For example, the voltage amplifier 120 may be a Class A amplifier which has good signal reproduction and linearity. The power source 130 includes portable battery packs, solar-powered units, and AC-powered systems, depending on application.

The microcontroller 140 is configured to control the supply of the voltage to the array of electrode lines 115, to modulate the non-uniform electric field dynamically, and to tune frequency (e.g., 10 Hz to 10 kHz), shape of the waveform (e.g., square wave, sine wave, pulsed DC), and voltage phase (e.g., two-phase or three-phase shifting). For example, the microcontroller 140 is configured to tune the frequency, shape of the waveform, and the voltage phase via pulse-width modulation (PWM). The microcontroller 140 is also configured to control timing, waveform (e.g., sinusoidal, pulsed DC, or modulated AC), and phase of the voltage signals applied to the array of electrode lines 115. The microcontroller 140 is also configured to enable programmable electric field strength and multi-phase output. The microcontroller 140 also interfaces the optical dust sensors (not shown) or the timers (not shown).

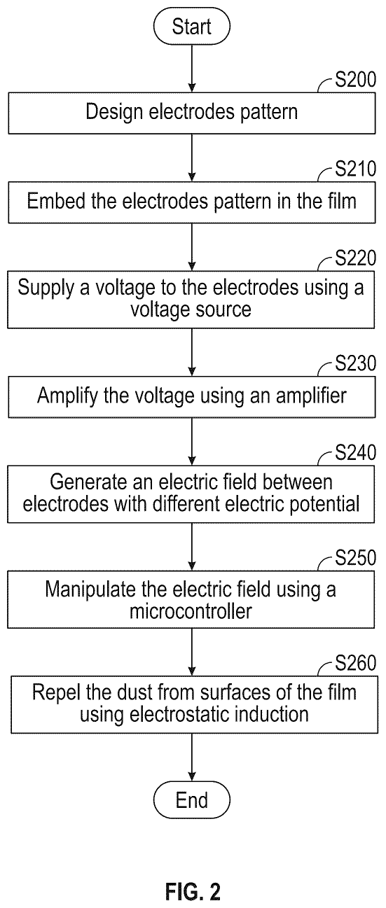

FIG. 2 describes a flowchart of the modular electrostatic film (MEF) method for removing dust particles in accordance with one or more embodiments of the disclosure.

Initially, in step S200, the electrode lines pattern is designed. The main challenge is ensuring the continuity of the electrode lines while allowing the MEF 110 to be cut to the desired size. This can be achieved by having repeatable main electrode lines with repeatable branch electrode lines in a repeatable design pitch. The main electrode lines with the same electrical phase are connected in the sides of the modular film design. The branch electrode lines may have different patterns such as straight lines, sine waves, pyramids, zig zags, and other patterns. If the branch electrode lines are not in a straight-lines pattern, there will be a dead electric field in the branch electrode lines that are cut from the main electrode line. Adjacent main electrode lines will need to have differential electric potential to ensure the existence of an electric field between them. When the MEF 110 is cut, electrical continuity is ensured by connecting the electrode lines with same electric potential by a conductive material.

In step S210, the array of electrode lines 115 is embedded into the MEF 110 forming a network that spans the entire surface of the MEF 110 to ensure uniform coverage and electric field generation.

In step S220, a voltage from the voltage source 130 is supplied to the array of electrode lines 115 to create a differential potential between adjacent electrode lines. Supplying the voltage to the array includes charging the dust particles by electrostatic induction.

In step S230, the voltage is amplified to a threshold electric potential by the voltage amplifier 120 which is electrically connected to the array 115 and the voltage source 130. The threshold electric potential is greater or equal to 500 volts.

In step S240, a non-uniform electric field is generated between the adjacent electrode lines with differential potential.

In step S250, the non-uniform electric field is manipulated by the microcontroller 140, which is electrically connected to the voltage source 130, by varying the frequency, the shape, and the phase of the voltage. The non-uniform electric field is manipulated to make it stronger which results in strong enough electrostatic repulsive forces to overcome adhesion forces and gravitational forces.

In step S260, the dust particles are repelled from the MEF 110 by the manipulated non-uniform electric field once the amplified voltage reaches the threshold electric potential. Repelling the dust particles from the MEF 110 includes overcoming, by electrostatic forces acting on the dust particles, gravitational forces and forces of adhesion acting on the dust particles. In a free body diagram of a dust particle, the electrostatic force acting to remove the dust particle from the surface is opposed by the adhesion force and the gravitational force that tend to keep the dust particle on the surface. With the threshold electric potential, the dust particle lifts off from the surface when charge induction results in a strong enough electrostatic repulsive force to overcome the adhesion force and the gravitational force.

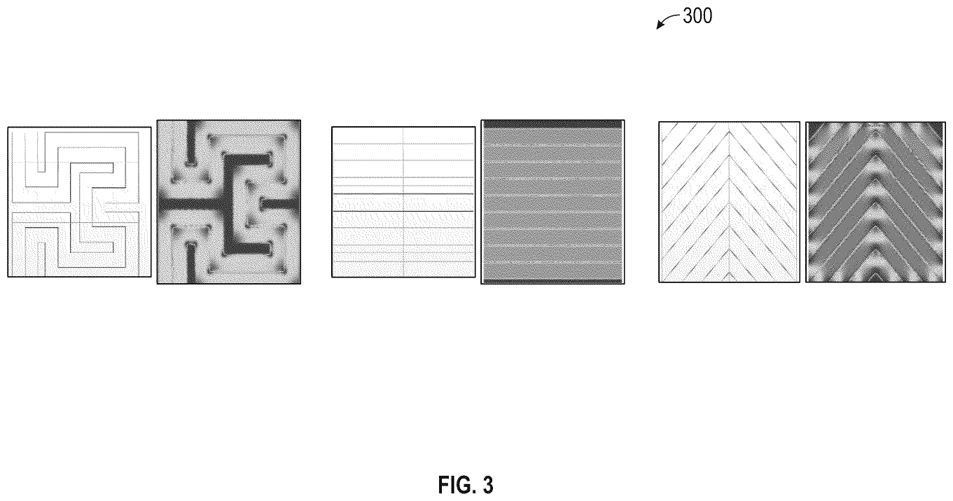

FIG. 3 illustrates various electrode lines patterns and corresponding electric field intensity distributions 300 in accordance with one or more embodiments of the disclosure. As shown in FIG. 3, the electric field magnitude is directly related to the differential electrical potential, the distance between the electrode lines, and the design of the electrode lines patterns. The electrode lines patterns influence the distribution and strength of the electric field generated. Bends in the pattern increase the intensity of the electric field locally. Designs with straight electrode lines have a uniform electrical field. Designs containing bends have high electric field over the bends and low electric field under the bends.

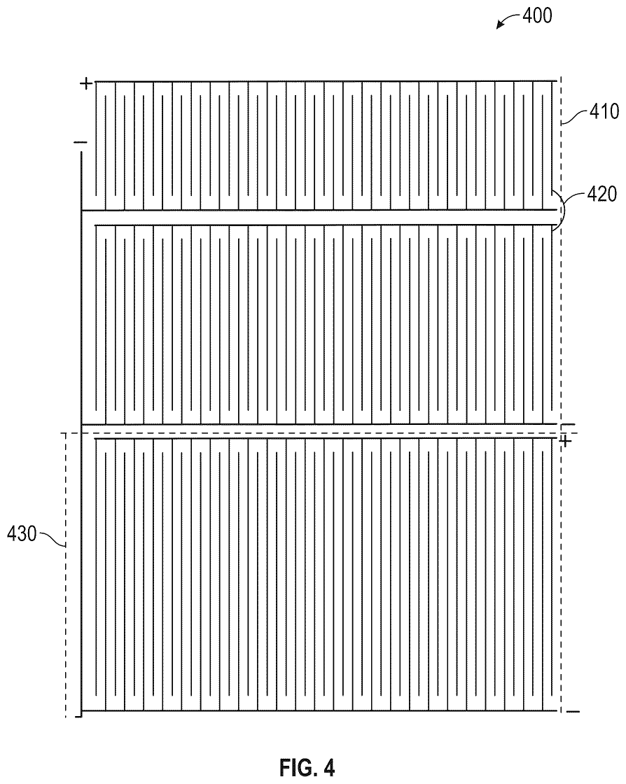

FIG. 4 depicts a corner cut of a two-phase MEF 400 showing possible cut lines 410 and conductive connections 420 in accordance with one or more embodiments of the disclosure. The thick electrode lines are the main electrode lines and the thin electrode lines are the branch electrode lines. When the two-phase MEF 400 is cut, continuity of the electrode lines is ensured by connecting the electrode lines with the same electric potential by a conductive connection 420 (conductive material). FIG. 2 FIG. 4 also shows a design pitch 430 which may be of varying sizes. A design pitch 430 with varying sizes may help cover different surface sizes. A two-phase MEF 400 with small pitch variations has more freedom in custom cutting and allowing to make precise coverage. However, in a two-phase MEF 400 with small pitch variations, the electric field has more dead spots due to the existence of more corners and vice versa.

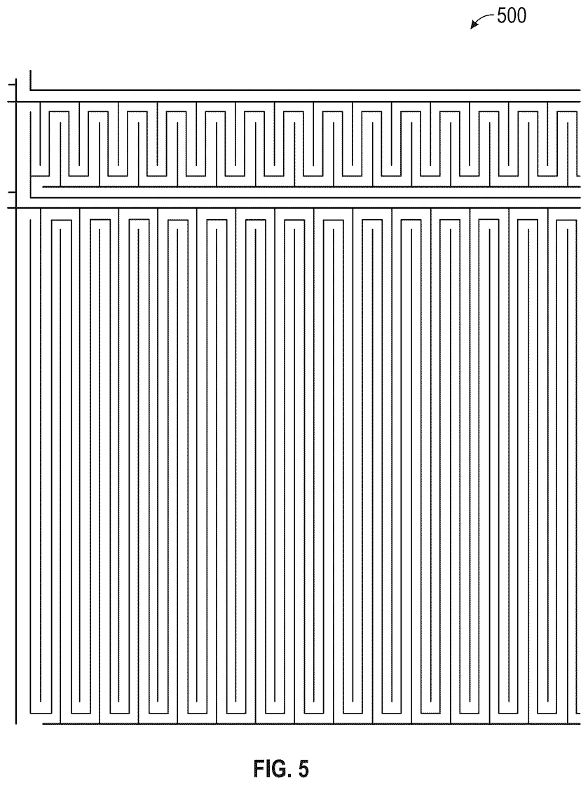

FIG. 5 demonstrates a corner cut of three-phase MEF 500 in accordance with one or more embodiments of the disclosure. The three-phase MEF 500 shown in FIG. 5 is a single layer design. It is possible to have a three-phase MEF 500 with electrode lines in a stack or multiple layers for increased efficiency.

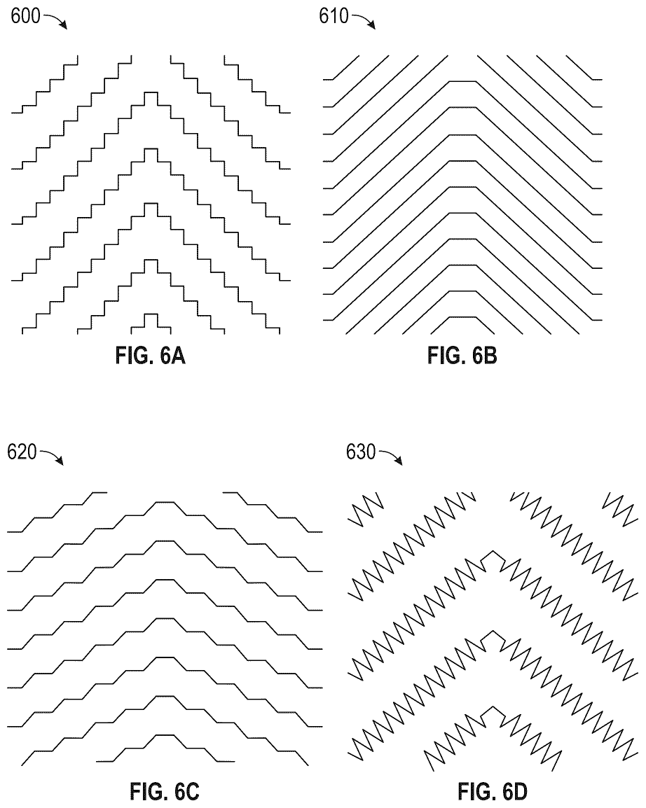

FIG. 6A, FIG. 6B, FIG. 6C, and FIG. 6D show various branch electrode lines patterns 600, 610, 620, and 630 in accordance with one or more embodiments of the disclosure. The branch electrode lines pattern 600 is a pyramid branch electrode lines, the branch electrode lines pattern 610 is a single side straight tip branch electrode lines, the branch electrode lines pattern 620 is a stair branch electrode lines, and the branch electrode lines pattern 630 is a zig zagged zag branch electrode lines.

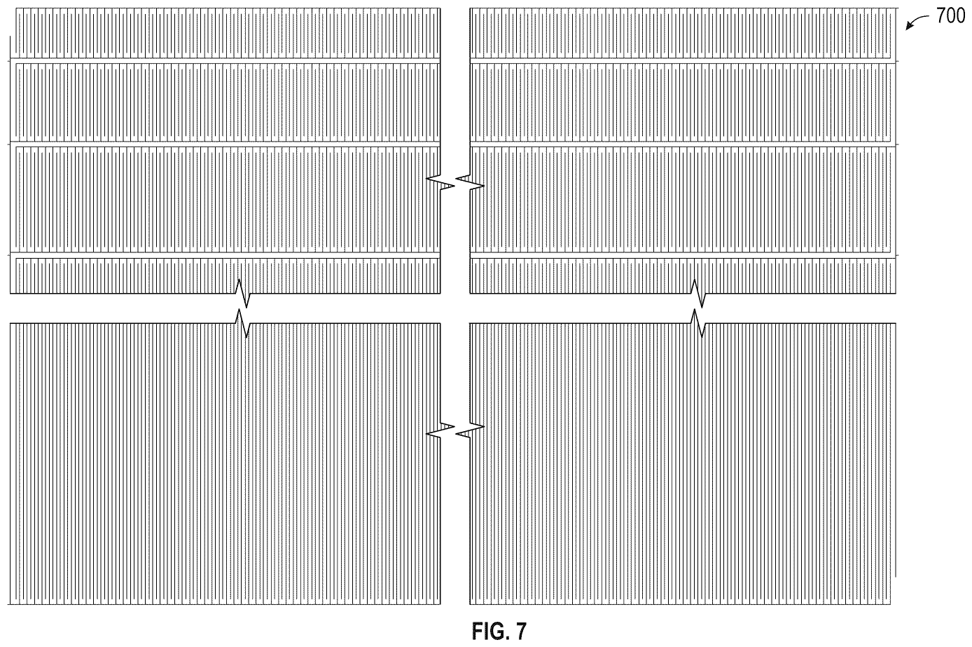

FIG. 7 explains an example of two-phase MEF 700 in accordance with one or more embodiments of the disclosure. The two-phase MEF 700 is designed for increased efficiency.

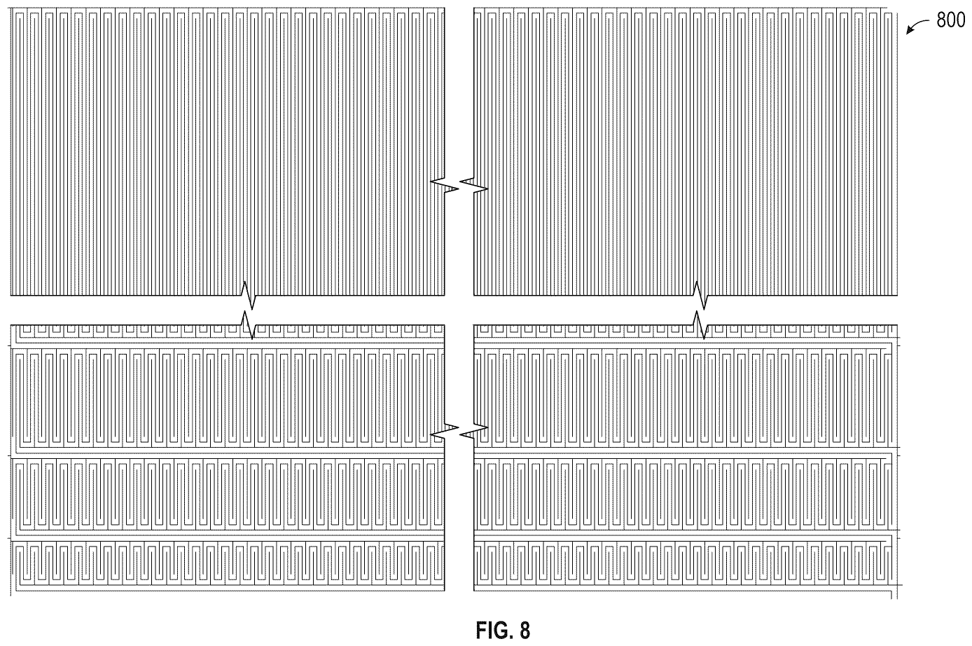

FIG. 8 exhibits an example of a three-phase MEF 800 design in accordance with one or more embodiments of the disclosure. The three-phase MEF 800 is designed for increased efficiency. In the three-phase MEF 800, the third phase line is looping around the first phase line and the second phase line. Custom cutting, tiling, having different line patterns and design pitch is possible in the design of the three-phase MEF 800.

Embodiments of the present disclosure may provide at least one of the following advantages. The film disclosed herein provides non-contact dust removal, adaptability to various surfaces and geometries, low-power consumption, scalable manufacturing using repeatable patterns, customizable pitch and pattern design for performance turning, and supports clear and opaque film options. The hydrophobic coating layer prevents the dust particles from cementing due to moisture exposure.

Embodiments of the present disclosure may also be integrated with portable, solar, or building-integrated power supplies. This design can fit any standard solar panel size. In other words, the design of the film disclosed herein has modularity to fit any panel size which other electrostatic cleaning systems lack. Other designs would have issues of discontinuity when a cut is needed to fit a panel. Other designs are also hard to tile for large panels while this design is easy and require low effort which current electrode printing service providers face limitations within large scale applications. Embodiments of the present disclosure may also be applied in civilian, commercial, and defense industries.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for removing dust particles on a modular electrostatic film configured to be applied on an apparatus, the method comprising:
arranging an array of electrode lines, the array comprising:
main electrode lines, and
branch electrode lines connected in a repeatable modular pattern, wherein the branch electrode lines are electrically connected to the main electrode lines;
embedding the array into the film, the film is further configured to be cut and tiled along predefined modular boundaries while maintaining electrical continuity of the array;
supplying a voltage to the array, by a voltage source electrically connected to the array, to create a differential electric potential between adjacent electrode lines;
amplifying the voltage, by a voltage amplifier electrically connected to the array and the voltage source, to a threshold electric potential;
generating a non-uniform electric field between the adjacent electrode lines;
manipulating the non-uniform electric field, by a microcontroller electrically connected to the voltage source, by varying frequency, shape, and phase of the voltage; and
repelling the dust particles from the film, by the manipulated non-uniform electric field, once the amplified voltage reaches the threshold electric potential.

2. The method according to claim 1, further comprising: applying a hydrophobic coating layer to an outer surface of the film, the hydrophobic coating layer is configured to prevent the dust particles from cementing.

3. The method according to claim 1, wherein adjacent main electrode lines have differential electrical potential.

4. The method according to claim 1, wherein the main electrode lines with same electric potential are connected by conductive material while custom cutting the film.

5. The method according to claim 3, wherein the main electrode lines are connected by conductive material while tiling the film.

6. The method according to claim 1, wherein the main electrode lines and the branch electrode lines have widths less than 100 microns.

7. The method according to claim 1, wherein spacing between adjacent electrode lines is less or equal to 1 mm.

8. The method according to claim 1, wherein the threshold electric potential is greater or equal to 500 volts.

9. The method according to claim 1, wherein the repeatable modular pattern includes straight lines, sine waves, pyramids, and zig zags.

10. The method according to claim 1, wherein supplying the voltage to the array includes charging the dust particles by electrostatic induction.

11. The method according to claim 10, wherein charging the dust particles includes generating electrostatic forces acting on the dust particles.

12. The method according to claim 11, wherein repelling the dust particles from the film includes overcoming, by electrostatic forces acting on the dust particles, gravitational forces and forces of adhesion acting on the dust particles.

13. A system for removing dust particles on a modular electrostatic film configured to be applied on an apparatus, the system comprising:
the modular electrostatic film embedded with an array of electrode lines, wherein the modular electrostatic film is further configured to be cut and tiled along predefined modular boundaries while maintaining electrical continuity of the array, wherein the array includes main electrode lines and branch electrode lines connected in a repeatable modular pattern, and wherein the branch electrode lines are electrically connected to the main electrode lines;
a voltage source electrically connected to the array, the voltage source is configured to:
supply a voltage to the array to create a differential electric potential between adjacent electrode lines, and
generate a non-uniform electric field between the adjacent electrode lines;
a voltage amplifier electrically connected to the array and the voltage source, the voltage amplifier is configured to amplify the voltage to a threshold electric potential;
a microcontroller electrically connected to the voltage source, the microcontroller is configured to manipulate the non-uniform electric field by varying frequency, shape, and phase of the voltage,
wherein the dust particles are repelled from the film, by the manipulated non-uniform electric field, once the amplified voltage reaches the threshold electric potential.

14. The system according to claim 13, further comprising: a hydrophobic coating layer applied to an outer surface of the film, the hydrophobic coating layer is configured to prevent the dust particles from cementing.

15. The system according to claim 13, wherein adjacent main electrode lines have differential electrical potential.

16. The system according to claim 13, wherein the main electrode lines with same electric potential are connected by conductive material while custom cutting the film.

17. The system according to claim 15, wherein the main electrode lines are connected by conductive material while tiling the film.

18. The system according to claim 13,
wherein the main electrode lines and the branch electrode lines have widths less than 100 microns,
wherein separation between the electrode lines is less or equal to 1 mm, and
wherein the threshold electric potential is greater or equal to 500 volts.

19. The system according to claim 13, wherein the repeatable modular pattern includes straight lines, sine waves, pyramids, and zig zags.

20. The system according to claim 13, wherein the voltage source is further configured to:
charge the dust particles by electrostatic induction,
generate electrostatic forces acting on the dust particles, and
repel the dust particles from the film by overcoming, using the electrostatic forces acting on the dust particles, gravitational forces and forces of adhesion acting on the dust particles.
